(19) United States
(12) Patent Application Publication
(10) Pub. No.: US 2005/0180637 A1
(43) Pub. Date: Aug. 18, 2005

(54) Motion classification support apparatus and motion classification device

(75) Inventors: Hitoshi Ikeda, Kanagawa (JP); Noriji Kato, Kanagawa (JP); Masahiro Maeda, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/058,651

(22) Filed: Feb. 16, 2005

(30) Foreign Application Priority Data
Feb. 18, 2004 (JP) 2004-041917
Nov. 4, 2004 (JP) 2004-321018

(51) Int. Cl. G06K 9/62; G06K 9/00

(52) U.S. Cl. 382/224; 382/106

(57) ABSTRACT

A motion classification support apparatus for supporting classification of motions of a subject includes an acquisition unit to acquire a plurality of image data in which the subject has been captured, a generation unit to generate predetermined area information pertaining to a capture condition of at least a predetermined single portion of the subject included in the acquired image data, a classification unit to create a classification of motions of the subject on a basis of the predetermined area information, and an indication unit to indicate a result of the classification.

### BACKGROUND OF THE INVENTION

1. Field of the Invention

The present invention relates to action classification support equipment and a motion classification device to perform processing pertaining to classification of motions of a subject, such as a person.

2. Description of the Related Art

For evaluation of efficiency of assembly work in a factory or efficiency of office work, motions of a person are classified. More specifically, for instance, a state of a person working in an office is captured by video, and motions of the person in the thus-captured motion picture data are identified and classified. By means of measuring a time period necessary for each task with use of the classification result, a statistic of needless motions, time-consuming tasks, and the like, is extracted, to thus evaluate task efficiency. In addition, by means of extracting a statistic of differences between a skilled operator and an unskilled operator, such as operation time, working efficiency of the operator is evaluated.

Conventionally, a device for detecting presence/absence of a moving target and/or a change in the background structure in a motion picture data is disclosed in, e.g., JP-A-2000-224542.

However, in the above-mentioned conventional device, there arises a problem of such incorrect classification that motions captured under different conditions, such as different locations or different orientations of a person's face, are classified as a single motion.

Accordingly, under the present circumstances, motion classification is manually performed by a user by himself/herself while watching a video. However, in such manual classification, decision criteria for classification differ for each user, which makes it difficult to perform uniform motion classification.

### SUMMARY OF THE INVENTION

The present invention has been conceived in view of the above problem, and provides a motion classification support apparatus which can perform uniform motion classification while taking a location or orientation of a face into consideration.

The present invention also provides a motion classification device which formulates a classification rule—in which a location or orientation of a face is taken into consideration and which can perform uniform motion classification—and which classifies image data of the target of classification, thereby enabling measurement or the like of operation time of each of the motions.

According to an aspect of the present invention, a motion classification support apparatus for supporting classification of motions of a subject includes an acquisition unit to acquire a plurality of image data in which the subject has been captured, a generation unit to generate predetermined area information pertaining to a capture condition of at least a predetermined single portion of the subject included in the acquired image data, a classification unit to create a classification of motions of the subject on a basis of the predetermined area information, and an indication unit to indicate a result of the classification.

According to another aspect of the present invention, a motion classification support apparatus for supporting classification of motions of a subject includes an acquisition unit to acquire a plurality of image data in which the subject has been captured, a tentative classification unit to create a tentative classification of motions of the subject on a basis of the acquired image data, a classification rule formulation unit to formulate a classification rule on a basis of a result of the tentative classification, a motion classification unit to create a motion classification of motions of the subject on a basis of the classification rule, and an indication unit to indicate a result of the motion classification.

According to yet another aspect of the present invention, a motion classification support method for supporting classification of motions of a subject with use of a computer includes acquiring a plurality of image data in which the subject has been captured, generating predetermined area information pertaining to a capture condition of at least a predetermined single portion of the subject included in the acquired image data, creating a classification of motions of the subject on a basis of the predetermined area information, and indicating a result of the classification.

According to still another aspect of the present invention, a motion classification support method for supporting classification of motions of a subject with use of a computer includes acquiring a plurality of image data in which the subject has been captured, creating a tentative classification of motions of the subject on a basis of the acquired image data, formulating a classification rule on a basis of a result of the tentative classification, creating a classification of motions of the subject on a basis of the classification rule, and indicating a result of the classification.

According to yet another aspect of the present invention, a motion classification support program for causing a computer to support classification of motions of a subject, the motion classification support method includes acquiring a plurality of image data in which the subject has been captured, generating predetermined area information pertaining to a capture condition of at least a predetermined single portion of the subject included in the acquired image data, creating a classification of motions of the subject on a basis of the predetermined area information, and indicating a result of the classification.

According to still another aspect of the present invention, a motion classification support program for causing a computer to support classification of motions of a subject, the motion classification support method includes acquiring a plurality of image data in which the subject has been captured, creating a tentative classification of motions of the subject on a basis of the acquired image data, formulating a classification rule on a basis of a result of the tentative classification, creating a classification of motions of the subject on a basis of the classification rule, and indicating a result of the classification.

According to yet another aspect of the present invention, a motion classification device for classifying motions of a subject includes an acquisition unit to acquire a plurality of image data in which the subject which is a target of classification processing has been captured, and a classification unit to create a classification of each of the image data for each motion of the subject with use of a classification rule formulated on a basis of sample image data. Preferably, a result of the classification is utilized in a predetermined processing.

### BRIEF DESCRIPTION OF THE DRAWINGS

Embodiments of the present invention will be described in detail based on the following figures, wherein:

FIG. 1 is a block diagram showing the principal configuration of a motion classification support apparatus according to a first embodiment of the invention;

FIG. 2 is a functional block diagram showing major processing performed by a control section of the motion classification support apparatus according to the first embodiment of the invention;

FIG. 3 is a flowchart showing an example of formulation of a classification rule by the control section of the motion classification support apparatus according to the first embodiment of the invention;

FIG. 4 is a flowchart showing an example of final classification performed by the control section of the motion classification support apparatus according to the first embodiment of the invention;

FIG. 5 is an explanatory view showing an example of motion classification result indicated to a user by the motion classification support apparatus according to the first embodiment of the invention;

FIG. 6 is a functional block diagram showing major processing performed by a control section of a motion classification device according to a second embodiment of the invention; and

FIG. 7 is an explanatory view showing an example of a motion classification result indicated to a user by the motion classification device according to the embodiment of the invention.

### DETAILED DESCRIPTION OF THE INVENTION

A first embodiment of the present invention will be described by reference to the drawings. Hereinbelow, the following case is taken as an example for description. That is, a state of a person working in an office (hereinafter, referred to as an “operator”) is captured by a video, and with use of a plurality of image data sets constituting the motion picture data, motions of the captured operator are classified.

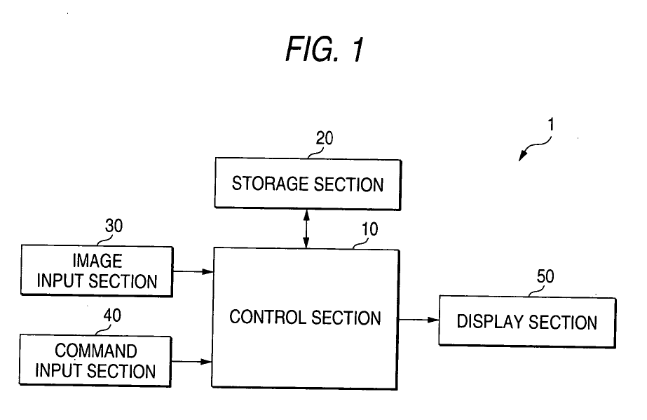

As shown in FIG. 1, a motion classification support apparatus 1 according to the embodiment includes a control section 10, a storage section 20, an image input section 30, a command input section 40, and a display section 50. The respective sections are connected to each other by means of a bus, and can be implemented with use of a so-called general computer. The computer may be incorporated in another product, such as a camera.

The control section 10 operates according to a program stored in the storage section 20, and acquires a plurality of image data sets for use in motion classification processing from the image input section 30. The control section 10 executes processing of generating predetermined area data pertaining to a capture condition (video-shooting requirements, posture, etc.) of a face of the operator included in the image data, processing of creating a tentative classification of motions of the captured operator on the basis of the predetermined area data, processing of formulating a classification rule on the basis of the tentative classification result, and processing of creating motion classification on the basis of the classification rule. The specific processing performed by the control section 10 will be detailed later.

The storage section 20 stores a program (software) executed by the control section 10. In addition, the storage section 20 serves also as a working memory for retaining a variety of data sets which are required by the control section 10 during the course of processing. More specifically, the storage section 20 can be implemented by a storage media such as a hard disk, or by a semiconductor memory, or a combination thereof.

The image input section 30 is connected to an external device such as a camera device, receives image data in which the operator has been captured through the external device, and outputs the image data to the control section 10.

The command input section 40 is connected to an input interface such as a keyboard or a mouse, receives a command from a user through the input interface, and outputs the command to the control section 10.

The display section 50 is, for instance, a display device or a printer device, and indicates the processing result by the control section 10 in accordance with a command input from the control section 10.

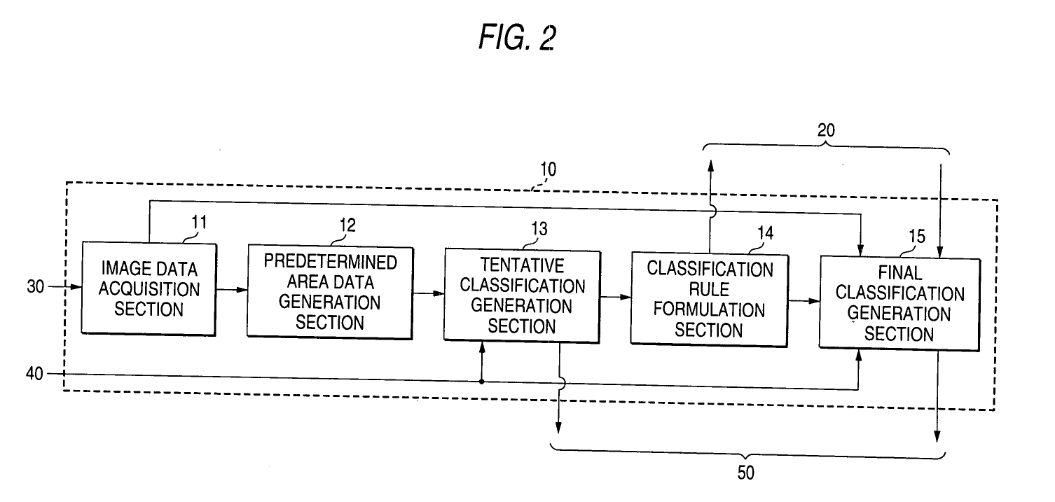

Next, processing performed by the control section 10 will be described specifically. FIG. 2 is a functional block diagram showing an example of processing by the control section 10. As shown in the drawing, the control section 10 according to the embodiment includes, in terms of functionality, an image data acquisition section 11, a predetermined area data generation section 12, a tentative classification creation section 13, a classification rule formulation section 14, and a final classification creation section 15.

The image data acquisition section 11 acquires image data (hereinafter, referred to as “sample image data”) having been captured with a face of the operator in a predetermined reference status (i.e., in predetermined video-shooting requirements and posture) from the image input section 30, and outputs the image data to the predetermined area data generation section 12. The sample image data are, for instance, such image data in which images of the operator's face facing forward with respect to the camera are captured.

In addition, the image data acquisition section 11 acquires image data (hereinafter, referred to as “target image data”) in which images of the operator (subject) who is a target of motion classification are captured, and outputs the image data to the predetermined area data generation section 12 and to the final classification section 15. The target image data are, for instance, all or some of a plurality of image data sets constituting motion picture data in which images of the operator during operation are captured.

The predetermined area data generation section 12 generates, on the basis of the sample image data received from the image data acquisition section 11, a database (hereinafter, referred to as a “converted database”) in which a predetermined area included in the sample image data, for instance, a face portion, has been converted into a predetermined capture condition. Referring to the converted database, the predetermined area data generation section 12 generates predetermined area data which indicates a capture condition of the face portion included in the target image data having been received from the image data acquisition section 11.

More specifically, the predetermined area data generation section 12 processes the predetermined area data by means of the kernel nonlinear subspace method. The kernel nonlinear subspace method is widely known as a method for classifying data into certain categories. Though detailed descriptions thereof are omitted, the outline of the method is as follows. Within a space F employing a feature element as its base, a plurality of subspaces Ω are each recognized to be of a category into which data are to be classified. A feature vector Φ created on the basis of data to be classified is projected to each of the subspaces Ω. A subspace Ω (hereinafter, referred to as a “nearest neighbor subspace”) having the smallest distance E—which is the distance between feature vector data φ after projection and feature vector data Φ before projection—is detected, and the data to be classified are determined to belong to a category indicated by the nearest neighbor subspace Q.

Accordingly, at a learning stage, at least one of nonlinear mapping (mapping to the space F, that is, a parameter included in a kernel function, and the like), and a hyperplane partitioning the subspaces Ω, each of which corresponds to the respective category, is adjusted, whereby the nearest neighbor subspaces Ω created on the basis of the feature vector data sets corresponding to a plurality of sample data sets for learning—which should belong to a single category—are merged into a single subspace.

More specifically, the predetermined area data generation section 12 generates a plurality of image data sets such that data on a face portion included in the sample image data (hereinafter, referred to as “converted image data”) having been converted in terms of predetermined conversion aspects (rotation, translation, resizing, and the like) by a predetermined conversion amount (a rotation angle, the number of pixels, a magnification/reducing ratio, and the like).

More specifically, the predetermined area data generation section 12 generates a plurality of sets of converted image data. For instance, each of the sample image data sets having been received from the image data acquisition section 11 is rotated by an angle ranging from −180 degrees to 130 degrees in increments of 5 degrees, shifted vertically and laterally by 5 pixels in each direction, and magnified in increments of 10% or reduced in size in increments of 10%, thereby generating a plurality of converted image data sets.

The predetermined area data generation section 12 generates feature vector data corresponding to each of the plurality of sets of converted image data, learns nonlinear mapping so that the distance E between the feature vector data and the subspace Ω corresponding to the conversion conditions (indicated by a combination of a conversion aspect and conversion amount) for use in generation of the converted image data attains a minimum value, and generates, for each conversion aspect, a converted database in which each of the converted image data sets and the conversion condition are associated, thereby storing the converted database in the storage section 20.

Next, the predetermined area data generation section 12 receives the target image data from the image data acquisition section 11, and maps each of the target image data sets (which can be considered identical with a vector value serving as an array of pixel values) to the feature vector (a set of features (variations) defined for each conversion aspect) in the space F while referring to the converted database stored in the storage section. The predetermined area data generation section 12 further projects the mapping to each of the subspaces Ω, thereby determining a nearest neighbor subspace (corresponding to each of the respective conversion conditions) at which the distance E between the feature vector data before projection and that after projection attains the smallest value.

Subsequently, the predetermined area data generation section 12 converts the target image data with use of the conversion condition corresponding to the nearest neighbor space. When the target image data after conversion are not of the reference status, the conversion processing corresponding to the nearest neighbor subspace with regard to the target image data after conversion is repeated. When the target image data after conversion are determined to be identical with the reference data (i.e., in the reference status), the predetermined area data generation section 12 generates predetermined area data that associates the conversion condition used for generating unconverted target image data with the target image data.

The predetermined area data are data associated with requirements used for converting the reference status of, e.g., a face portion included in each of the target image data sets, for instance, an angle showing in-image-plane rotation such as rightward or leftward rotation or an angle showing depth wise rotation in an image such as upward or downward rotation, or coordinates or the number of pixels indicating a location or size in an image. The predetermined area data generation section 12 outputs the predetermined area data to the tentative classification creation section 13.

The tentative classification creation section 13 creates, with use of the predetermined area data received from the predetermined area data generation section 12, the feature vector indicating each of the conversion conditions of each of the plurality of sets of target image data. The tentative classification creation section 13 creates a tentative classification of motions on the basis of the distances between the plurality of feature vectors, thereby outputting the tentative classification result to the display section 50.

More specifically, the tentative classification creation section 13 calculates, for instance, Mahalanobis distances between the feature vectors, and performs a hierarchical clustering by use of a nearest neighbor method, thereby repeatedly classifying target image data sets having short Mahalanobis distances therebetween into a single cluster.

The tentative classification creation section 13 calculates a distance between a centroid (e.g., a mean vector) of each of the clusters generated by the clustering and the feature vector on the basis of the target image data classified into the cluster, specifies a single target image data set having the smallest distance value as the representative image data, and causes the display section 50 to display the representative image data of each of the clusters.

Furthermore, in a case where a correction command is received from a user of the motion classification support apparatus 1 by way of the command input section 40 with regard to the tentative classification result indicated by the display section 50, the tentative classification creation section 13 corrects the tentative classification result on the basis of the correction command, and outputs the thus-corrected tentative classification result to the classification rule formulation section 14. In addition, in a case where no correction command is given by the user, the tentative classification creation section 13 outputs the initial tentative classification result to the classification rule formulation section 14.

The classification rule formulation section 14 formulates a classification rule indicating a classification criterion of motions on the basis of the tentative classification result received from the tentative classification creation section 13 (in a case where correction is performed, the tentative classification result after correction). More specifically, the classification rule is data which associate the respective clusters, into which motions are classified, with the predetermined area data corresponding thereto (the feature vectors indicating the conversion conditions of the face portion). The classification rule formulation section 14 stores the thus-formulated classification rule into the storage section 20.

As described above, the control section 10 formulates a classification rule on the basis of the captured condition of the face portion of the operator, and stores the classification rule into the storage section 20. When the control section 10 receives a command by way of the command input section 40 from a user to perform motion classification, the control section 10 reads out the classification rule stored in the storage section 20, and in accordance with the classification rule performs motion classification processing of the target image data having been received by way of the image input section 30.

More specifically, with use of the classification rule read out from the storage section 20 and in accordance with the command from the user, the final classification creation section 15 performs motion classification (referred to as a “final classification” for differentiation from the tentative classification created by the tentative classification creation section 13) of each of the plurality of target image data sets having been received from the image data acquisition section 11.

More specifically, the final classification creation section 15 maps the target image data set which is an target of the final classification processing into the feature vector in the space F, and further projects the mapping to the subspace Ω corresponding to each of the clusters indicated by the classification rule, thereby calculating a distance between the feature vector before projection and the same after projection. The final classification creation section 15 determines a cluster having the smallest distance value as the cluster into which the motion of the target image data is to be classified, and outputs the final classification result to the display section 50.

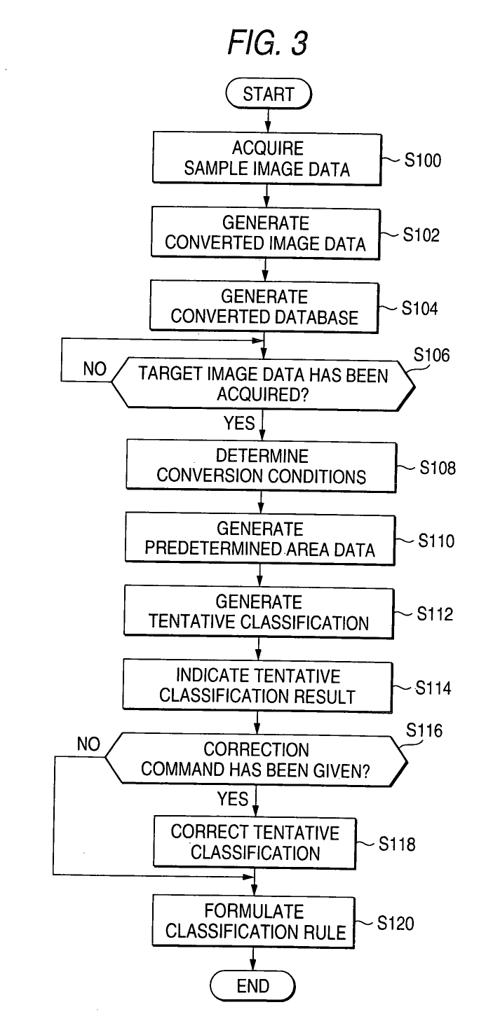

Next, a flow of formulation of the classification rule by the control section 10 will be described by reference to the flowchart shown in FIG. 3. As shown in the drawing, the image data acquisition section 11 acquires the sample image data (S100), and outputs the data to the predetermined area data generation section 12. The predetermined area data generation section 12 generates the converted image data on the basis of the thus-received sample image data (S102), further generates the converted database through learning with use of the converted image data, and stores the database into the storage section 20 (S104).

Next, the image data acquisition section 11 determines whether or not the target image data have been acquired from the image input section 30 (S106). If the data have not been acquired (the result of determination is No), the image data acquisition section 11 maintains the stand-by state, and if the data have been acquired (the result of determination is Yes), the image data acquisition section 11 outputs the thus-acquired target image data to the predetermined area data generation section 12.

The predetermined area image generation section 12 reads out the converted database from the storage section 20, and determines the conversion conditions of the target image data on the basis of the database and the target image data received from the image data acquisition section 11 (S108). The predetermined area image generation section 12 generates predetermined area data in which the thus-determined conversion conditions and the target image data are associated, thereby outputting the data to the tentative classification creation section 13 (S110).

The tentative classification creation section 13 performs clustering on the basis of the predetermined area data received from the predetermined area image generation section 12, thereby creating a tentative classification (S112), and outputs the tentative classification result to the display section 50, to thus indicate the result to the user (S114).

Furthermore, the tentative classification creation section 13 determines whether or not a correction command has been given from a user by way of the command input section 40 on the thus-indicated tentative classification result (S116), and when no correction command has been given (the result of determination is No), the tentative classification result created in the process S112 is output to the classification rule formulation section 14 as is. When a correction command has been given (the result of determination is Yes), the tentative classification result is corrected in accordance with the correction command (S118), and the tentative classification result after correction is output to the classification rule formulation section 14.

The classification rule formulation section 14 formulates a classification rule on the basis of the tentative classification result received from the tentative classification creation section 13 (in a case where the result is corrected, the tentative classification result after correction) (S120), and stores the classification rule in the storage section 20.

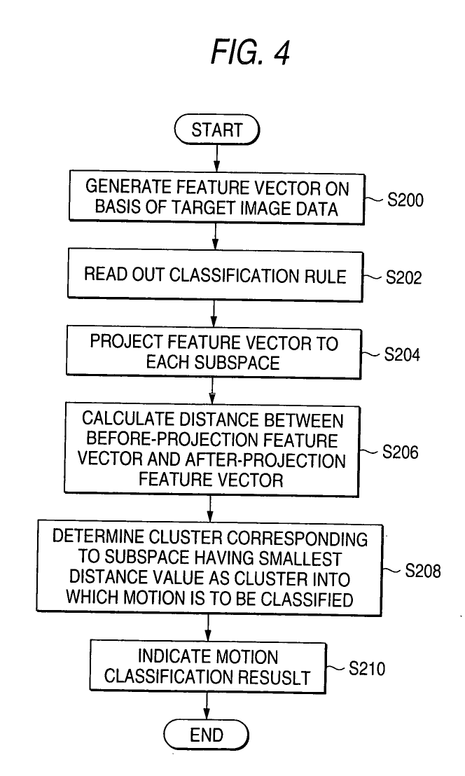

Next, a flow for creating the final classification with use of the classification rule stored in the control section 20 will be described by reference to the flowchart shown in FIG. 4. As shown in the drawing, when the final classification creation section 15 receives a command from a user to perform motion classification processing, by way of the command input section 40, the final classification creation section 15 maps the target image data to be classified to the space F and having been received from the image data acquisition section 11, thereby generating a feature vector (S200).

Furthermore, the final classification creation section 15 reads out the classification rule from the storage section 20 (S202), and projects the feature vector generated in the process of S200 to the subspace Ω corresponding to each of the clusters indicated by the thus-read-out classification rule (S204), thereby calculating a distance between the feature vector before projection and the same after projection (S206).

The final classification creation section 15 determines a cluster corresponding to a subspace having the smallest distance value as the cluster into which the motion of the target image data is to be classified (S208), and outputs the motion classification result to the display section 50, thereby indicating the result to the user (S210).

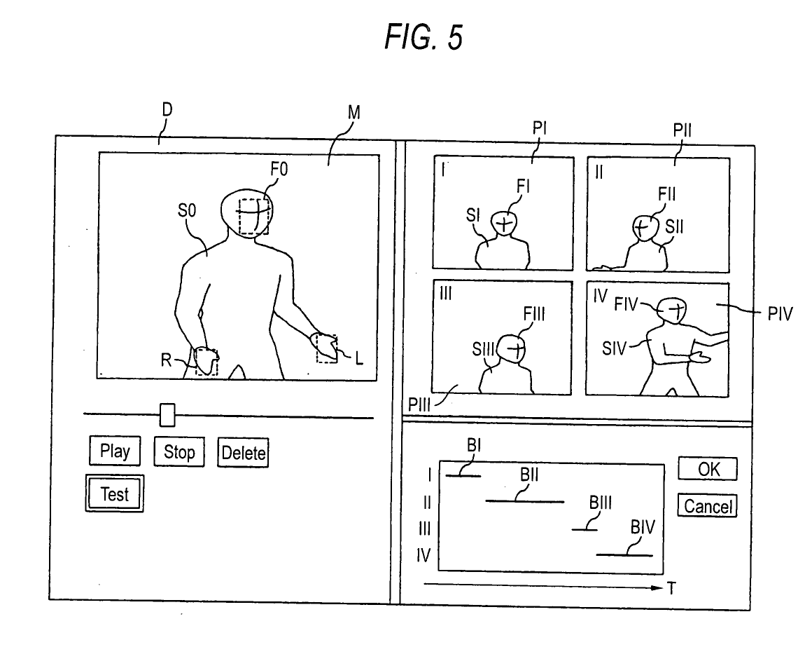

FIG. 5 shows an example of the motion classification results indicated to the user by the display section 50. In the example, a stationary image M, which is included in the motion picture data in which images of an operator S0 in an office are captured, is displayed on the left side of an screen D for displaying the motion classification result. In the stationary image M, an image region determined to be a face portion of the operator S0 having been captured is indicated as a rectangular region F0 enclosed by a dotted line.

In addition, on the upper right portion of the screen D, images PI to PIV, each of which is a representative image of four clusters having been generated by the motion classification process, are indicated. The representative images PI to PIV respectively show images of the operator, SI to SIV, in which image-pickup status of face portions FI to FIV differ from each other.

In the example, each of three clusters I to III, in which each of the face portions FI to FIII is in the lower portion of the respective representative image PI to PIII, is classified as a task performed by each operator SI to SIII while in a sitting posture. In addition, the three clusters I to III with regard to desk work differ from each other in orientations of the face portions FI to FIII of the respective representative images PI to PIII. Accordingly, the tasks are classified as being different tasks. The fourth cluster IV, in which the face portion FIV of the representative image PIV is in the upper portion, is classified as a task performed by the operator SIV in a standing posture.

Meanwhile, in the example, motion classification is performed in accordance with the hierarchical clustering processing. Accordingly, as a higher hierarchy classification result, the result of the motion classification can be displayed hierarchically by means of, for instance, classifying as motions of a single type the result on the three clusters I to III with regard to the desk work is classified.

Furthermore, on the lower right portion of the screen D, operations—each of which corresponds to one of the four clusters I to IV—and duration time—during which the operation is performed in the motion picture data—are displayed while being associated as a result of clustering (variations with time of the operations) in a direction of the temporal axis T. More specifically, operations classified into the four clusters I to IV are displayed as bars BI to BIV located at different locations in relation to the temporal axis T of the motion picture data while being distinguished from each other. The length of each of the four bars BI to BIV shows a time period required for each of the operations, thereby allowing the bars to be utilized in evaluation of efficiency in an office and the like.

As described above, according to the motion classification support apparatus 1 according to the embodiment, identification of a capture condition of a face of an operator who is a target of the motion classification, and motion classification on the basis of a uniform classification rule are enabled.

Meanwhile, the embodiment has been described while taking an example in which the subject is a person, however, the invention is not limited thereto, and can be applied to any subject, such as an animal, or a vehicle, so long as the subject can be a target of motion classification. In addition, the predetermined area of the subject is not limited to a face. For instance, in a case of a person, hands and/or feet can be used in addition to a face.

For instance, in a case where hands are employed as the predetermined area, it is assumed that, in an example shown in FIG. 5, the right hand R and left hand L of the person S0 indicated by the rectangular region enclosed with the dotted line in the image M shown on the left portion of the screen D are taken as predetermined areas. Predetermined area data indicating a positional relationship between the hands and the face portion F0 are generated, to thus perform further detailed motion classification.

In addition, the embodiment has been described while taking an example in which the predetermined area data generation section 12 generates the predetermined area data by means of the kernel nonlinear subspace method, however, the invention is not limited thereto, and another method, such as an auto-encoder, may be employed.

The tentative classification creation section 13 is not limited to a hierarchical clustering, and may create a tentative classification by means of a K-Means method, or the like. In addition, the tentative classification creation section 13 or the final classification creation section 15 may determine a classification result to be output to the display section 50 on the basis of the volume of the target image data (e.g., total volume of the data, or the number of images) classified to each of the clusters.

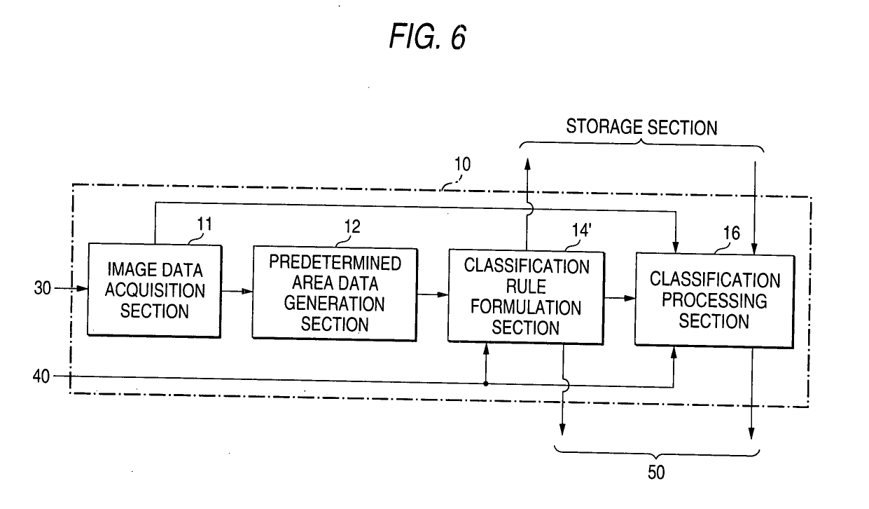

More specifically, for instance, the tentative classification creation section 13 or the final classification creation section 15 calculates a time period pertaining to the motion—having been classified into each of the clusters—on the basis of the volume of the target image data classified into the cluster. When the time period does not exceed a predetermined threshold value, a classification result—with motions classified to the cluster having been deleted therefrom—is output to the display section 50. In this case, as the time period pertaining to each of the motions, there may be calculated an accumulated time period in which the motion having been performed within the image-capture time of the motion picture data are summed, or a time period during which each of the motions has been continuously conducted (duration time) A motion classification device 1′ according a second embodiment of the invention is analogous to that of the motion classification support apparatus 1 shown in FIG. 1, except that operations of the control section 10 differ slightly. More specifically, the control section 10 of the motion classification device 1′ includes, in terms of function, the image data acquisition section 11, the predetermined area data generation section 12, a classification rule formulation section 14′, and a classification processing section 16 as shown in FIG. 6.

In the following descriptions, elements whose operations are similar to those of the elements of the motion classification support apparatus 1 according to the first embodiment are denoted by the same reference numerals, and repeated descriptions thereof are omitted.

The classification rule formulation section 14′ generates, with use of the predetermined area data received from the predetermined area data generation section 12, a feature vector indicating each of the conversion conditions of each of the plurality of sample image data sets, and on the basis of distances between the plurality of feature vectors, creates a classification of motions.

More specifically, the classification rule formulation section 14′ calculates, for instance, Mahalanobis distances between the feature vectors, and repeatedly performs a hierarchical clustering in accordance with a nearest neighbor method, thereby classifying into a single cluster target image data sets having short Mahalanobis distances therebetween.

The classification rule formulation section 14′ calculates a distance between a centroid (e.g., a mean vector) of each of the clusters generated by the clustering and the feature vector on the basis of the target image data classified into the cluster, and specifies a single target image data set having the smallest distance value as the representative image data.

The classification rule formulation section 14′ formulates a classification rule which indicates a classification criterion of motions on the basis of the classification result. More specifically, the classification rule is information for associating the respective clusters into which motions are classified with the predetermined area data corresponding thereto (the feature vectors indicating the conversion conditions of the face portion). The classification rule formulation section 14′ stores the thus-formulated classification rule in the storage section 20.

As described above, the control section 10 formulates a classification rule on the basis of the capture condition of the face portion of the captured operator in the sample image data, and stores the classification rule in the storage section 20. When the control section 10 receives a command from a user to perform motion classification by way of the command input section 40, the control section 10 reads out the classification rule stored in the storage section 20, and in accordance with the classification rule performs motion classification processing of the target image data having been received by way of the image input section 30.

Specifically, the control section 10 starts processing of the classification processing section 16 in accordance with the command from the user. More specifically, with use of the classification rule read out from the storage section 20 the control section 10 performs motion classification of each of the plurality of target image data sets having been received from the image data acquisition section 11.

The classification processing section 16 maps the target image data which is a target of the classification processing into the feature vector in the space F, and further projects the mapping to the subspace Ω corresponding to each of the clusters indicated by the classification rule, thereby calculating a distance between the feature vector before projection and the same after projection. The classification processing section 16 determines a cluster having the smallest distance value as the cluster into which the motion with regard to the target image data is to be classified, and outputs the classification result to the display section 50.

In other words, the control section 10 classifies each of the target image data included in the motion picture data to each of the clusters. Accordingly, the following may be performed. For instance, from a frame rate R (data indicating the number of frames of target image data generated per unit time) of the motion picture data and the number of frames classified into the i^{th} cluster, a time Ti required for a motion pertaining to the i^{th} cluster is obtained using:
Ti=R×Ni,
and the calculation result is output to and displayed on the display section 50.

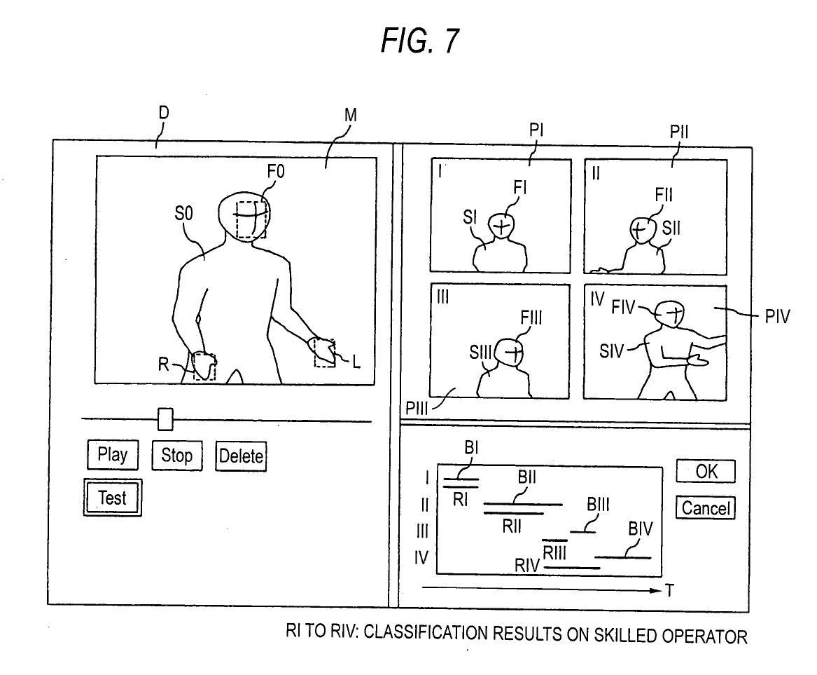

Furthermore, as shown in FIG. 7, which corresponds to FIG. 5, on the lower right portion of the screen D, as a result of clustering (variations with time of the operation) in the direction of the temporal axis T, operations—each of which corresponds to one of the clusters (in this embodiment, four clusters I to IV corresponding to FIG. 5)—and time period—during which the operation is performed in the motion picture data—may be displayed while being associated. More specifically, the operation classified into each of the clusters is displayed as bars BI to BIV located at different locations in relation to the temporal axis T of the motion picture data while being distinguished from each other. The length of each of the four bars BI to BIV shows a time period required for the corresponding operation. Furthermore, classification results RI to RIV of another operator who has been measured in advance may be displayed by means of adding the bars. For instance, when classification results on a skilled operator serving as the above-mentioned other operator are displayed, the results can be utilized for evaluation of work efficiency for each of the operators. In addition, the operator may be the operator who has been captured in the sample image data for use in formulation of the classification rule. In other words, the classification results on the sample image data may be additionally displayed.

The motion classification support apparatus may be configured so as to further include a generation unit to generate predetermined area information pertaining to a capture condition of at least a predetermined single portion of the subject included in the acquired image data. Preferably, the tentative classification unit creates a tentative classification on a basis of the predetermined area information.

The motion classification support apparatus may be configured to further include a command receipt unit to indicate a result of the tentative classification and to receive a command from a user. Preferably, the tentative classification unit corrects the tentative classification result on a basis of the received command, and the classification rule formulation unit formulates a classification rule on a basis of a result of the corrected tentative classification.

The motion classification support apparatus may be configured such that the predetermined area information includes information on at least one of a location, angle, and size of the predetermined area.

The entire disclosure of Japanese Patent Applications No. 2004-041917 filed on Feb. 18, 2004 and No. 2004-321018 filed on Nov. 4, 2004 including specifications, claims, drawings and abstracts is incorporated herein by reference in its entirety.

1. A motion classification support apparatus for supporting classification of motions of a subject, comprising:
an acquisition unit to acquire a plurality of image data in which the subject has been captured;
a generation unit to generate predetermined area information pertaining to a capture condition of at least a predetermined single portion of the subject included in the acquired image data;
a classification unit to create a classification of motions of the subject on a basis of the predetermined area information; and
an indication unit to indicate a result of the classification.

2. A motion classification support apparatus for supporting classification of motions of a subject, comprising:
an acquisition unit to acquire a plurality of image data in which the subject has been captured;
a tentative classification unit to create a tentative classification of motions of the subject on a basis of the acquired image data;
a classification rule formulation unit to formulate a classification rule on a basis of a result of the tentative classification;
a motion classification unit to create a motion classification of motions of the subject on a basis of the classification rule; and
an indication unit to indicate a result of the motion classification.

3. The motion classification support apparatus according to claim 2, further comprising:
a generation unit to generate predetermined area information pertaining to a capture condition of at least a predetermined single portion of the subject included in the acquired image data,
wherein the tentative classification unit creates a tentative classification on a basis of the predetermined area information.

4. The motion classification support apparatus according to claim 2, further comprising:
a command receipt unit to indicate a result of the tentative classification and to receive a command from a user,
wherein the tentative classification unit makes a correction of the result of the tentative classification on a basis of the received command, and
the classification rule formulation unit formulates a classification rule on a basis of a result of the correction of the tentative classification.

5. The motion classification support apparatus according to claim 1,
wherein the predetermined area information includes information on at least one of a location, angle, and size of the predetermined area.

6. The motion classification support apparatus according to claim 3,
wherein the predetermined area information includes information on at least one of a location, angle, and size of the predetermined area.

7. A motion classification support method for supporting classification of motions of a subject with use of a computer, comprising:
acquiring a plurality of image data in which the subject has been captured;
generating predetermined area information pertaining to a capture condition of at least a predetermined single portion of the subject included in the acquired image data;
creating a classification of motions of the subject on a basis of the predetermined area information; and
indicating a result of the classification.

8. A motion classification support method for supporting classification of motions of a subject with use of a computer, comprising:
acquiring a plurality of image data in which the subject has been captured;
creating a tentative classification of motions of the subject on a basis of the acquired image data;
formulating a classification rule on a basis of a result of the tentative classification;
creating a classification of motions of the subject on a basis of the classification rule; and
indicating a result of the classification.

9. A motion classification support program for causing a computer to support classification of motions of a subject, the motion classification support method comprising:
acquiring a plurality of image data in which the subject has been captured;
generating predetermined area information pertaining to a capture condition of at least a predetermined single portion of the subject included in the acquired image data;
creating a classification of motions of the subject on a basis of the predetermined area information; and
indicating a result of the classification.

10. A motion classification support program for causing a computer to support classification of motions of a subject, the motion classification support method comprising:
acquiring a plurality of image data in which the subject has been captured;
creating a tentative classification of motions of the subject on a basis of the acquired image data;
formulating a classification rule on a basis of a result of the tentative classification;
creating a classification of motions of the subject on a basis of the classification rule; and
indicating a result of the classification.

11. A motion classification device for classifying motions of a subject, comprising:
an acquisition unit to acquire a plurality of image data in which the subject which is a target of classification processing has been captured; and
a classification unit to create a classification of each of the image data for each motion of the subject with use of a classification rule formulated on a basis of sample image data,
wherein a result of the classification is utilized in a predetermined processing.
